(19) United States
(12) Patent Application Publication
(10) Pub. No.: US 2005/0169215 A1
(43) Pub. Date: Aug. 4, 2005

(54) Method for selecting transport format combination

(75) Inventors: Tung-Chu Cheng, Hukou Township (TW); Chih-Hsin Lee, Jinning Township (TW)

Correspondence Address: SNELL & WILMER;ONE ARIZONA CENTER, 400 EAST VAN BUREN, PHOENIX, AZ, 850040001, US

(73) Assignee: BENQ CORPORATION

(21) Appl. No.: 11/051,219

(22) Filed: Feb. 4, 2005

(30) Foreign Application Priority Data
Feb. 4, 2004 (TW) 93102499

(51) Int. Cl. H04B 7/216

(52) U.S. Cl. 370/335; 370/342

(57) ABSTRACT

A method for selecting an appropriate transport format combination in a wireless transmission unit suitable for use in a wireless communication system is provided. The method includes the steps of sorting all possible transport format combinations, comparing their transport relative power parameters with a reference relative power parameter to obtain a pointer, and selecting an appropriate transport format combination according to the pointer.

### CROSS-REFERENCE TO RELATED APPLICATIONS

This Application claims the right of priority based on Taiwan Patent Application No. 093102499 filed on Feb. 4, 2004.

### FIELD OF INVENTION

The present invention relates to a method for selecting an appropriate transport format combination in a wireless transmission unit.

### BACKGROUND OF THE INVENTION

Wireless communication systems have been widely used for transmitting voice and/or text messages. The data processing methods of these communication systems can be divided into CDMA, TDMA, FDMA and other DMA techniques. CDMA is the most widely used method, and it is usually required to comply with the related industrial standards, such as IS-95, CDMA 2000, and W-CDMA, etc.

In W-CDMA, multiple transport channels can inter-transmit data in the physical layer. Each transport channel can transport one or more transport formats, and each transport format has many parameters associated with data processing, such as the transmission time interval (TTI), the data size transmittable, the number of transport blocks acceptable in each TTI, the coding scheme of the transport block, etc. Using different transport formats allows different types of data to be transmitted through the same medium, namely, the transport channel. In a transmission time interval, a particular transport format combination (TFC) defines a transport format for each transport channel, the transport format combination being selected from a group consisted of possible transport format combinations (TFCS).

For W-CDMA, the following ways can reduce the transmission time in a limited bandwidth: reducing the data amount to be transmitted, increasing the coding rate, and increasing the data rate. Sometimes, the system providers cannot control the reduction of the data amount to be transmitted; however, if the transmission power can be increased so as to obtain a better energy-per-bit-to-total-noise-plus-interference ratio, then the increase of the coding rate and the data rate can be achieved. Since not all of the transport format combinations have the same bits to be transmitted, in order to maintain the quality of service, each transport format combination has to have a unique value of power. Based on each individual transport power corresponding to the transport power the wireless transmission unit can provide, it can be divided into the supported state, the excess-power state, and the blocked state. In the supported state and the excess-power state, the transport format combinations have equal chances to be selected for transmission, while in the blocked state; the transport format combinations have no chance of transmission.

To sum up the above, given the limited power a system can provide, selecting the best transport format combination to transport has a great impact on system performance. Thus, it is very important to determine the value of transport format combination power that can be sustained by the system.

### SUMMARY OF THE INVENTION

The present invention provides a method for selecting an appropriate transport format combination in a wireless transmission unit. The transmission unit is used in a wireless communication system. The transmission unit mentioned herein can be a base station or a mobile communication device.

The wireless transmission unit includes N possible transport format combinations and a reference relative power parameter. In the above-mentioned N transport format combinations, N being a positive integer, and each transport format combination corresponds to a transport relative power parameter. The transport relative power parameter is associated with the dedicated physical control channel (DPCCH) power of the wireless communication system and the dedicated physical data channel (DPDCH) power of each transport format combination. The reference relative power parameter is associated with the DPCCH power.

The method of the present invention includes the following steps: (1.1) sorting the N transport format combinations based on the sizes of the transport relative power parameters; (1.2) comparing the transport relative power parameters with the reference relative power parameter after sorting, and obtaining a pointer; and (1.3) selecting an appropriate transport format combination based on the transport format combinations designated by the pointer obtained in step (1.2).

Wherein, step (1.2) includes the following steps: (4.1) selecting a transport format combination as a comparison combination from the N transport format combinations, and pointing the pointer to the comparison combination; (4.2) determining in the Y continuous time intervals, whether the transport relative power parameter of the comparison combination is smaller than the reference relative power parameter in the X time intervals; (4.3) if the transport relative power parameter of the comparison combination is smaller than the reference comparison power parameter in the X time intervals, then determining whether the pointer is pointed to the transport format combination with the largest transport relative power parameter after sorting; (4.4) if the pointer did not point to the transport format combination with the largest transport relative power parameter after sorting, then pointing the pointer to the transport format combination second largest to the transport format combination of the comparison combination; (4.5) designating the transport format combination pointed by the pointer in step (4.4) as the comparison combination; and (4.6) determining in the Y continuous time intervals whether the transport relative power parameter of the comparison combination is smaller than the reference relative power parameter in the X time intervals. If so, returning to step (4.3).

Step (1.2) further includes the following steps: (7.1) if the transport relative power parameter of the comparison combination in step (4.2) is not smaller than the reference relative power parameter in the X time intervals, then determining whether the pointer points to the transport format combination with the smallest transport relative power parameter after sorting; (7.2) if the pointer did not point to the transport format combination with the smallest transport relative power parameter after sorting, then pointing by the pointer to the transport relative power parameter second smallest to the transport format combination of the comparison combination; (7.3) designating the transport relative power parameter pointed by the pointer in step (7.2) as the comparison combination; (7.4) determining whether all of the transport relative power parameter of the comparison combination is smaller than the reference relative power parameter in the Z continuous time intervals; (7.5) if in step (7.4) all of the transport relative power parameter of the comparison combination were not determined to be smaller than the reference relative power parameter in the Z continuous time intervals, then returning to step (7.1); (7.6) if all of the transport relative power parameter of the comparison combination are determined in step (7.4) to be smaller than the reference relative power parameter in the Z continuous time intervals, then defining the comparison combination as a threshold transport format combination; and (7.7) if in step (7.1) the pointer is determined to point to the transport format combination with the smallest transport relative power parameter after sorting, then indicating that none of the transport format combination is appropriate, and setting a flag as “TRUE” to indicate that none of the N transport format combinations is available.

### BRIEF DESCRIPTION OF THE DRAWINGS

FIG. 1 is the data flow diagram of the method of the present invention;

FIG. 2 is the data flow diagram in accordance with the first embodiment of the present invention;

FIG. 3 is the partial data flow diagram when executing step 102 of the method of the present invention;

FIG. 4 is the partial data flow diagram when executing step 102 of the method of the present invention;

FIG. 5 is the partial data flow diagram when executing step 102 of the method of the present invention; and

FIG. 6 is the data flow diagram in accordance with the second embodiment of the present invention.

### DETAILED DESCRIPTION

The present invention is suitable for use in a W-CDMA system having a wireless transmission unit for transmitting data. When transmitting data, the W-CDMA system sends a control signal simultaneously, wherein the control signal includes signals such as a transmit power control command, a pilot, and a transport format combination indicator.

The channel responsible for transmitting data is called a dedicated physical data channel (DPDCH), while that for transmitting control signals is a dedicated physical control channel (DPCCH). In each time interval, the DPCCH power is usually a fixed value, while the DPDCH power is a specific ratio of the DPCCH power. Based on the ratio, the power needed for the DPDCH to transmit data in each time interval can be calculated. The ratio is defined as a transport relative power parameter in this specification. In addition, a reference relative power parameter defined in this specification is the ratio between the largest power the wireless transmission unit can provide and the DPCCH power.

The present invention utilizes the transport relative power parameter and the reference relative power parameter to determine which power of the transport format combination can be sustained by the system, and to further determine which transport format combination can be used for data transmission.

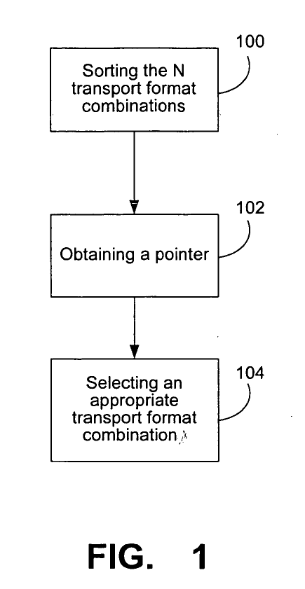

As shown in FIG. 1, the method of the present invention provides the steps as described in the following. When executing step 100, the wireless transmission unit sorts the N transport format combinations based on the size of the transport relative power parameter. The sorting order can be from large to small or from small to large, as the present invention is not limited to any particular sequence.

When executing step 102, the wireless transmission unit compares the transport relative power parameter with the reference relative power parameter based on the order after sorting, so as to obtain a pointer that points to a threshold transmission format combination.

When executing step 104, the wireless transmission unit selects an appropriate transport format combination in accordance with the pointer.

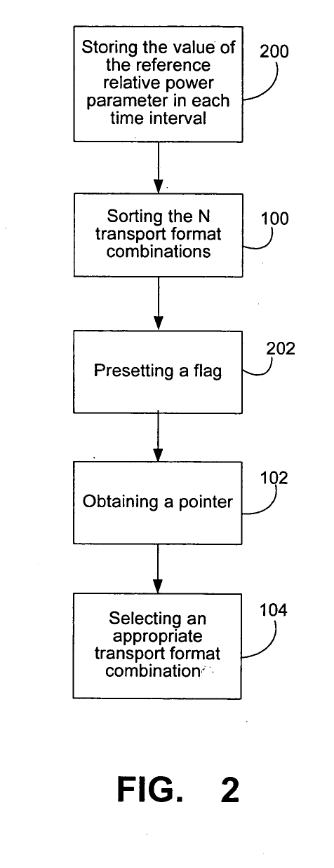

Since when comparing the transport relative power parameter with the reference relative power parameter, the present invention considers the transport relative power parameters and the reference relative power parameter in the Y continuous time intervals, where y is a positive integer, the method in accordance with the first embodiment of the present invention as shown in FIG. 2 further includes step 200: in the Y continuous time intervals, storing the value of the reference relative power parameter in each time interval.

In addition, the wireless transmission unit further includes a flag for indicating whether none of the above-mentioned N transport format combinations is appropriate. The method defines that if none of the transport format combinations is appropriate, the flag is set to “TRUE,” and if not all of the above-mentioned transport format combinations are inappropriate, the flag is set to “FALSE.” As shown in step 202, the method further includes presetting the flag to “FALSE” so as to indicate that not all of the N transport format combinations are inappropriate.

It is to be noted that, the order of steps 200, 100, and 202 in FIG. 2 can be alternately changed. Besides the order of step 200 to step 100 to step 202 shown in the figure, the order of step 200 to step 202 to step 100, or that of step 100 to step 200 to step 202, or other execution sequence is protected within the scope of the present invention.

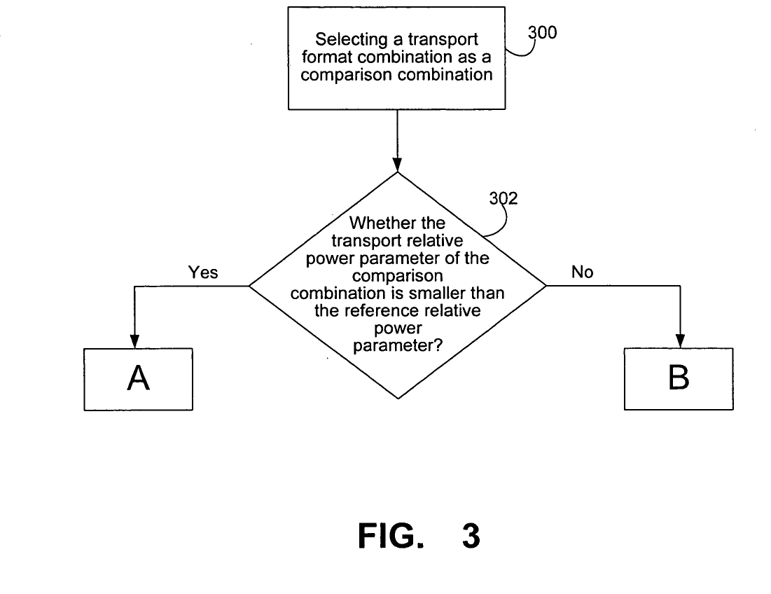

In order to describe step 102 in further details, the method of the present invention can be broken down into steps as shown in FIGS. 3, 4, and 5.

Referring to FIG. 3, when executing step 300, the wireless transmission unit selects a transport format combination as a comparison combination from the above-mentioned N transport format combinations, and points the pointer to the comparison combination. The present invention does not limit the way the wireless transmission unit selects the initial comparison combination in step 300. In other words, the wireless transmission unit can select the transport format combination with the smallest transport relative power parameter as the initial comparison combination, or select the transport format combination with the largest transport relative power parameter as the initial comparison combination or any other transport format combination as the initial comparison combination.

When executing step 302, the wireless transmission unit determines in the Y continuous time intervals whether the transport relative power parameter of the comparison combination is smaller than the reference relative power parameter in the X time intervals, where X is a positive integer smaller than Y. The present invention does not limit the X time intervals to be continuous or not. If the transport relative power parameter of the comparison combination is smaller than the reference relative power parameter in the X time intervals, it indicates that at least one of the transport format combinations can be used, and the present invention then executes step A. If not, it indicates that it is yet to determine whether a transport format combination is available for use, and thus executes step B to continue determining whether any other transport format combinations can be used.

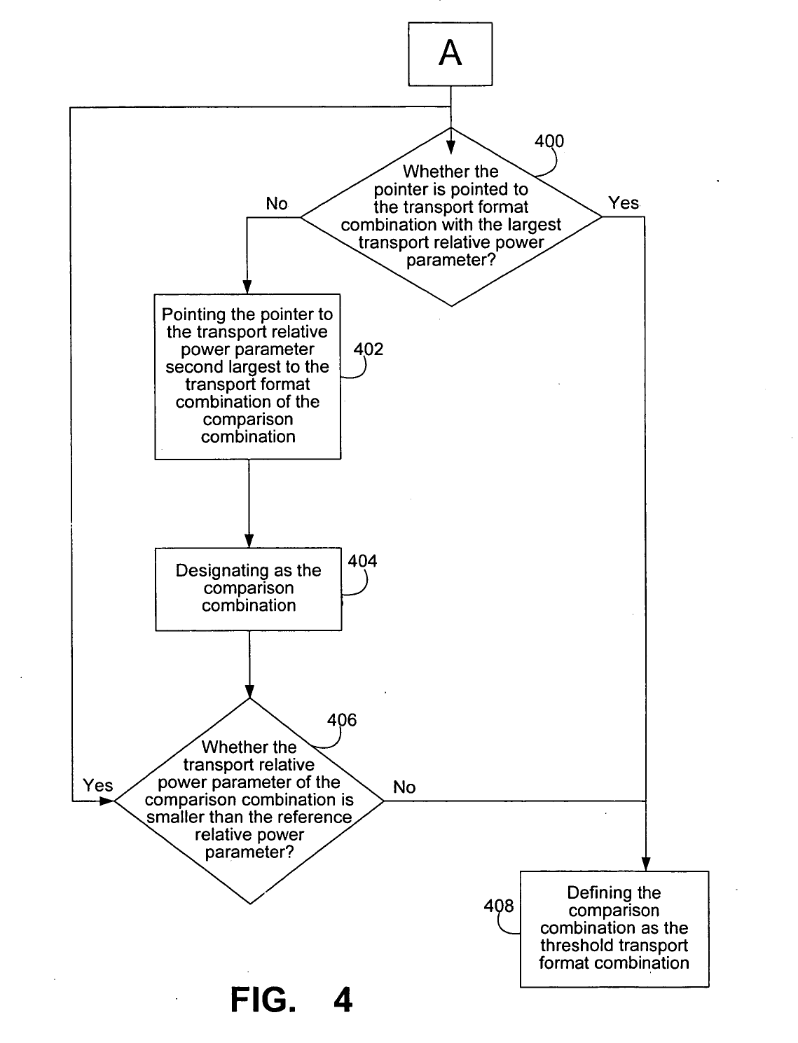

If in step 302, the transport relative power parameter of the comparison combination is determined to be smaller than the reference relative power parameter in the X time intervals, then it continues executing step 400 as shown in FIG. 4, and further determines whether the pointer is pointed to the transport format combination with the largest transport relative power parameter after sorting.

If the pointer did not point to the transport format combination with the largest transport relative power parameter after sorting, it executes step 402 to point the pointer to the transport relative power parameter second largest to the transport format combination of the comparison combination.

When executing step 404, it designates the transport format combination pointed by the point as the comparison combination.

When executing step 406, it determines in the Y continuous time intervals whether the transport relative power parameter of the comparison combination is smaller than the reference relative power parameter in the X time intervals. If so, it returns to step 400, and continues to determine whether a larger transport relative power parameter is available for use.

If in step 406, the transport relative power parameter of the comparison combination is not determined in the Y continuous time intervals to be smaller than the reference relative power parameter in the X time intervals, then it indicates that the comparison combination already has the largest transport relative power parameter among all available transport format combinations. Now, the present invention executes step 408 to define the comparison combination as the threshold transport format combination, meaning all transport relative power parameters having a smaller transport relative power parameter than that of the threshold transport format combination are appropriate transport format combinations. If in step 100, the order sequence is from small to large, then the transport format combinations before the threshold transport format combination after sorting all have the DPDCH power the system can sustain, and thus appropriate. On the other hand, the DPDCH power of the transport format combinations after the threshold transport format combination exceeds the amount the system can sustain, and thus inappropriate.

If in step 400, the pointer is determined to point to the transport format combination with the largest transport relative power parameter after sorting, then it indicates that no transport format combination with a larger transport relative power parameter is available for comparison. The present invention then executes step 408 to define the comparison combination as the threshold format combination.

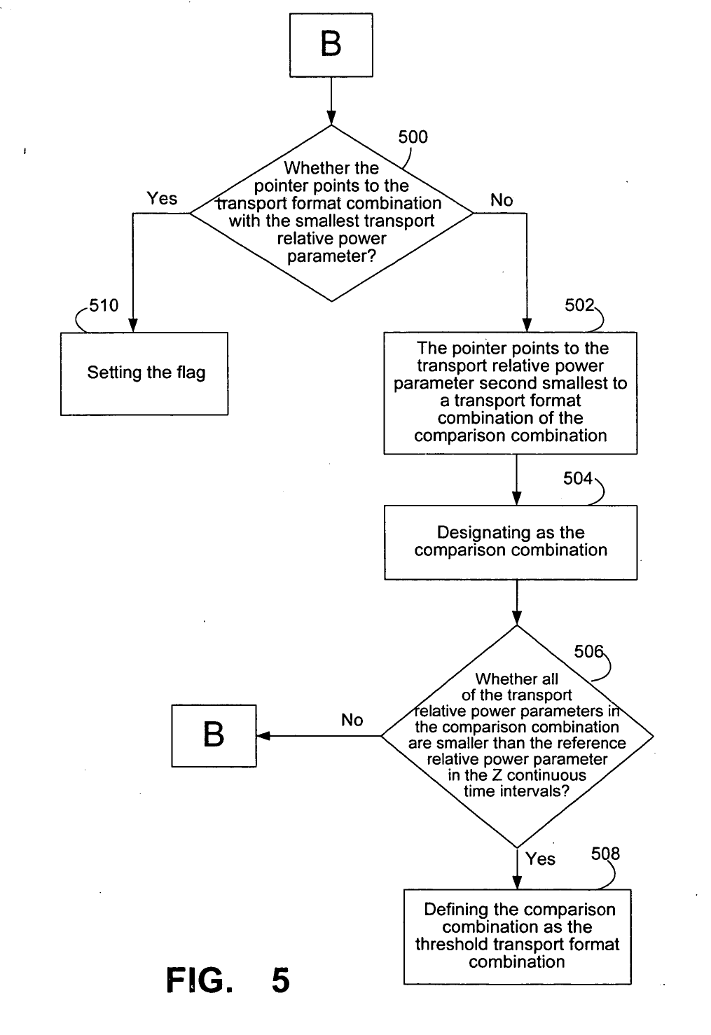

If in step 302, the transport relative power parameter of the comparison combination is determined not to be smaller than the reference relative power parameter in the X time intervals, then the present invention executes step 500 as shown in FIG. 5 to determine whether the pointer points to the transport format combination with the smallest transport relative power parameter. If not, it continues determining whether an appropriate transport format combination is available. Then the present invention executes step 502.

When executing step 502, the pointer points to the transport relative power parameter second smallest to a transport format combination of the comparison combination.

When executing step 504, it designates the transport format combination pointed by the pointer in step 502 as the comparison combination.

When executing step 506, it determines whether all of the transport relative power parameters in the comparison combination is smaller than the reference relative power parameter in the Z continuous time intervals, Z being a positive integer smaller than Y. If so, then it continues executing step 508.

When executing step 508, the present invention defines the comparison combination as the threshold transport format combination.

If the transport relative power parameter of the comparison combination is not determined in step 506 to be smaller than the reference relative power parameter in the Z continuous time intervals, then the present invention returns to step 500 to continue determining whether a transport format combination with a smaller transport relative power parameter is available for use.

If in step 500, the pointer is determined in step 500 to point to a transport format combination with the smallest transport relative power parameter after sorting, then step 510 is executed to set the flag as “TRUE” to indicate none of the N transport format combination is appropriate.

After the above-mentioned steps to determine the appropriate transport format combination as the threshold transport format combination, the present invention then executes step 104 of FIG. 2, selecting an appropriate transport format combination from the transport relative power parameters smaller than that of the threshold transport format combination.

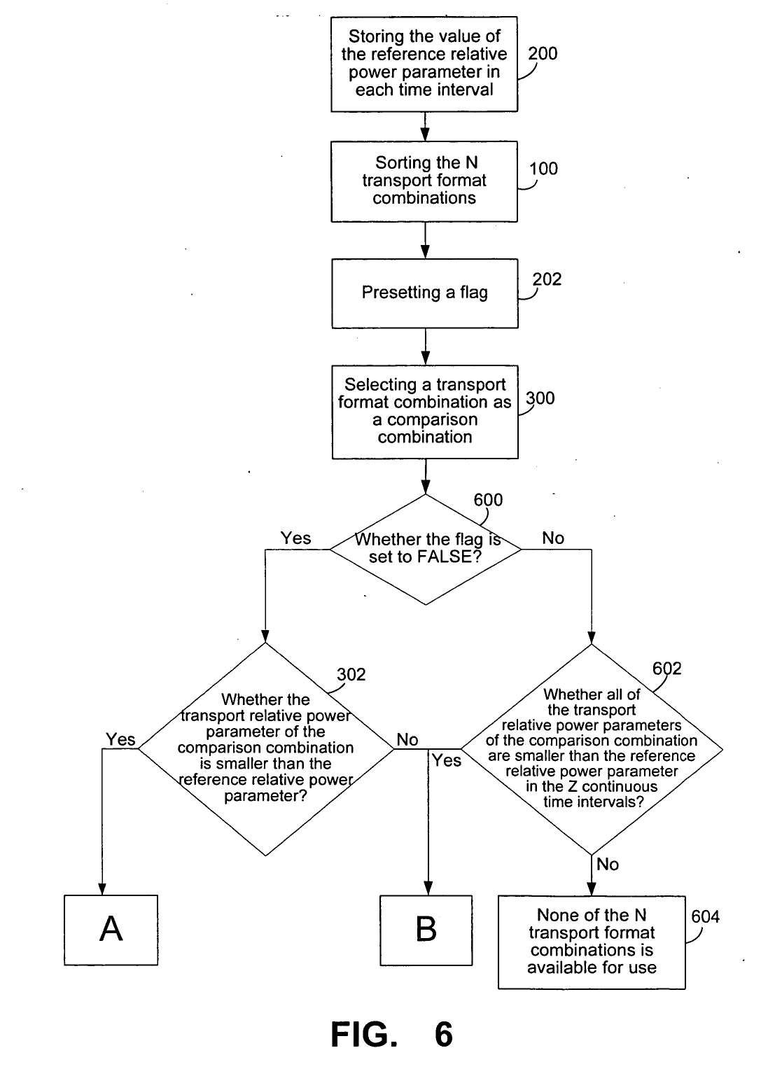

FIG. 6 is the second embodiment of the present invention. Different from the first embodiment, the method in accordance with the second embodiment executes step 600 after executing step 300 to determine whether the flag is set to “FALSE.” If so, it executes step 302. The steps after that are the same as those in the first embodiment, and thus are not described hereinafter.

If the flag is determined to be “TRUE” in step 600, then it indicates that none of the current transport format combinations is available for use. The present invention then executes step 602 to determine whether the transport relative power parameter of the comparison combination is smaller than the reference relative power parameter in the Z continuous time intervals. If so, it executes step B, namely executes the steps as shown in FIG. 5. If not, as shown in step 604, the present invention determines that none of the transport format combinations is available for use.

Through the method of the present invention, the wireless transmission unit can determine whether the DPDCH of each of the transport format combinations can be sustained by the system so that the wireless transmission unit can select the best transport format combination from one or more appropriate transport format combinations for data transmission.

By means of the detailed descriptions of what is presently considered to be the most practical and preferred embodiments of the subject invention, it is expected that the features and the gist thereof be clearly described. Nevertheless, these embodiments are not intended to be construed in a limiting sense. Instead, it will be well understood that any analogous variations and equivalent arrangements will fall within the spirit and scope of the invention.

1. A method for selecting an appropriate transport format combination in a wireless transmission unit suitable for use in a wireless communication system, said transmission unit comprising:
N transport format combinations, each transport format combination having a transport relative power parameter associated with a dedicated physical control channel (DPCCH) power of said wireless communication system and a dedicated physical data channel (DPDCH) power of each of said transport format combinations, wherein N is a positive integer; and
a reference relative power parameter associated with said dedicated physical control channel power;
said method comprising:
(1.1) sorting said N transport format combinations based on the sizes of said transport relative power parameter;
(1.2) comparing said transport relative power parameters with said reference relative power parameter based on the result of the sorting, and obtaining a pointer; and
(1.3) selecting said appropriate transport format combination based on said pointer.

2. The method of claim 1, further comprising:
(2) in Y time intervals, storing the value of said reference relative power parameter in each time interval, wherein Y is a positive integer.

3. The method of claim 2, wherein said wireless transmission unit comprises a flag for indicating whether none of said N transport format combinations is appropriate, said method further comprising:
(3) pre-setting said flag to “FALSE” to indicate not all of said N transport format combinations are inappropriate.

4. The method of claim 3, wherein said step (1.2) further comprises:
(4.1) selecting a transport format combination from said N transport format combinations as a comparison combination, and pointing said pointer to said comparison combination;
(4.2) determining in said Y time intervals whether said transport relative power parameter of said comparison combination is smaller than said reference power parameter in X time intervals, wherein X is a positive integer smaller than Y;
(4.3) determining whether said pointer points to a transport format combination with the largest transport relative power parameter after sorting, if said transport relative power parameter of said comparison combination is smaller than said reference relative power parameter in X time intervals;
(4.4) pointing said pointer to a transport format combination with the second largest transport relative power parameter, if said pointer did not point to a transport format combination with the largest transport relative power parameter after sorting;
(4.5) designating said transport format combination pointed by said pointer in step (4.4) as said comparison combination; and
(4.6) determining in said Y time intervals, whether said transport relative power parameter of said comparison combination is smaller than said reference relative power parameter in X time intervals, if so, return to step (4.3).

5. The method of claim 4, wherein step (1.2) further comprises:
(5) defining said comparison combination as a threshold transport format combination, if in step (4.6) said transport relative power parameter of said comparison combination is not determined in said Y time intervals to be smaller than said reference relative power parameter in X time intervals.

6. The method of claim 4, wherein step (1.2) further comprises:
(6) defining said comparison combination as a threshold transport format combination, if in step (4.3), said pointer is determined to point to said transport format combination with the largest transport relative power parameter after sorting.

7. The method of claim 4, wherein step (1.2) further comprises:
(7.1) determining whether said pointer points to said transport format combination with the smallest transport relative power reference after sorting, if in step (4.2) said transport relative power parameter of said comparison combination was not smaller than said reference relative power parameter in X time intervals;
(7.2) pointing said pointer to a transport format combination with said transport relative power parameter second largest to said comparison combination, if said pointer did not point to said transport format combination with the smallest transport relative power reference after sorting;
(7.3) designating said transport format combination pointed by said pointer in step (7.2) as said comparison combination;
(7.4) determining whether all of said transport relative power parameter of said comparison combination is smaller than said reference relative power parameter in Z continuous time intervals; and
(7.5) returning to step (7.1), if in step (7.4), said transport relative power parameter of said comparison combination is not determined to be all smaller than said reference relative power parameter in continuous Z time intervals.

8. The method of claim 7, wherein step (1.2) further comprises:
(8) defining said comparison combination as a threshold transport format combination, if in step (7.4), said transport relative power parameter of said comparison combination is determined to be all smaller than said reference relative power parameter in Z continuous time intervals.

9. The method of claim 7, wherein step (1.2) further comprises:
(9) setting said flag to “TRUE” to indicate none of said N transport format combinations is appropriate, if in step (7.1), said pointer is determined to point to said transport format combination with the smallest transport relative power parameter after sorting.

10. The method of claim 5, wherein step (1.3) further comprises:
(10) selecting said appropriate transport format combination from one or more transport format combinations with said transport relative power parameter smaller than said transport relative power parameter of said threshold transport format combination.

11. The method of claim 6, wherein step (1.3) further comprises:
(11) selecting said appropriate transport format combination from one or more transport format combinations with said transport relative power parameter smaller than said transport relative power parameter of said threshold transport format combination.

12. The method of claim 8, wherein step (1.3) further comprises:
(12) selecting said appropriate transport format combination from said one or more transport format combinations with said transport relative power parameter smaller than said transport relative power parameter of said threshold transport format combination

13. The method of claim 7, wherein step (1.2) further comprises:
(13.1) determining whether said flag is set to “FALSE,” if so, execute step (4.2);
(13.2) determining whether said transport relative power parameter of said comparison combination is smaller than said reference relative power parameter in Z continuous time intervals, if said flag is “TRUE”; and
(13.3) executing step (7.1), if said transport relative power parameter of said comparison combination is determined to be smaller than said reference relative power parameter in Z continuous time intervals.
